(19) United States
(12) Patent Application Publication
(10) Pub. No.: US 2022/0312738 A1
(43) Pub. Date: Oct. 6, 2022

(54) Manual Treadmill for Pets

(71) Applicant: Robert Lee Bloom, San Diego, CA (US)

(72) Inventor: Robert Lee Bloom, San Diego, CA (US)

(21) Appl. No.: 17/495,704

(22) Filed: Oct. 6, 2021

Related U.S. Application Data
(60) Provisional application No. 63/170,993, filed on Apr. 5, 2021.

(51) Int. Cl. A01K 15/02

(52) U.S. Cl. CPC A01K 15/027

(57) ABSTRACT

Systems of the inventive subject matter are directed to manual treadmills for animals like dogs. Systems include a platform frame that is formed as a rectangular piece having an interior space. A rear roller is coupled with a back portion of that interior space, and a front roller is coupled with adjustment blocks disposed within a front portion of the frame. The adjustment blocks can be moved by rotating knobs to adjust tension of a belt that couples with the rear roller and front roller. A belt platform is also disposed between the front roller and the rear roller. Front legs of the system can be used to adjust angle of the platform frame relative to horizontal, and the leash frame height can similarly be adjusted.

This application claims priority to U.S. Provisional Patent Application Ser. No. 63/170,993, filed Apr. 5, 2021. All extrinsic materials identified in this application are incorporated by reference in their entirety.

### FIELD OF THE INVENTION

The field of the invention is treadmills for dogs and other animals.

### BACKGROUND

The background description includes information that may be useful in understanding the present invention. It is not an admission that any of the information provided in this application is prior art or relevant to the presently claimed invention, or that any publication specifically or implicitly referenced is prior art.

Making sure your pet gets enough exercise can be a challenge. Different animals, especially dogs, can need a wide range of different activity levels, ranging from border collies on one extreme to English bulldogs on the other. It isn't always easy to get out for a long walk, a run, or to throw the ball—this can be especially true for people in more urban environments. One option to help get pets enough exercise is to get them started with exercise equipment built specifically for the animal. Treadmills for dogs is one such manifestation of this need.

U.S. Pat. No. 6,722,316 teaches a treadmill for dogs, but it teaches the use of a motor-driven belt, adding complexity that drives up cost, not to mention requiring a power source for its motor, which can lead to a disruptively loud machine. This invention fails to consider advantages that can be achieved by eliminating the need for a power source and making a device that is purely manually driven.

U.S. Pat. No. 6,837,186 also teaches a treadmill for dogs, but, again, this patent teaches the use of a computerized system with a motor driven belt. And although manual treadmills currently exist, such as the “Sunny Health and Fitness 7700,” these devices have not been specialized for use by dogs and similarly fail to include new features that improve usability and convenience of a manual treadmill for a pet.

These and all other extrinsic materials discussed in this application are incorporated by reference in their entirety. Where a definition or use of a term in an incorporated reference is inconsistent or contrary to the definition of that term provided in this application, the definition of that term provided in this application applies and the definition of that term in the reference does not apply.

Thus, it has yet to be appreciated that manual treadmills for dogs represent a large market and have not yet been fully developed into convenient, market-ready products.

### SUMMARY OF THE INVENTION

The present invention provides apparatuses, systems, and methods in directed to manual treadmills for pets. In one aspect of the inventive subject matter, a manual treadmill for animals is contemplated, the treadmill comprising: a platform frame comprising a rear frame, a left frame, a right frame, and a front frame, where the rear frame, the left frame, the right frame, and the front frame create the platform frame as a rectangle; a rear roller coupled between the left frame and the right frame at a back portion of the platform frame; a tension adjustment mechanism comprising a knob affixed to a threaded rod with the threaded rod passing through an adjustment block having an internally threaded portion, where the adjustment block is disposed within a front portion of the right frame; where the right frame comprises a slot and wherein the adjustment block comprises a hole that is aligned with the slot; a front roller having a peg that is sized and dimensioned to pass through the slot to couple with the hole on the adjustment block; a belt platform disposed between the rear frame, the front frame, the left frame, and the right frame; and a belt connecting the rear roller to the front roller such that the belt platform is disposed within the belt.

In some embodiments, the treadmill also includes a leash frame, where the leash frame couples with both the right frame and the left frame, and the leash frame comprises a connection point. The treadmill can also include front legs coupled with the platform frame at a front portion, where the front legs comprise through holes to facilitate angle adjustments of the platform frame relative to horizontal. A horizontal cross member that couples with the front legs can also be included. In some embodiments, a sheet of material that couples with the horizontal cross member and the front legs is also included to improve sheer strength of the structure. In some embodiments, the internally threaded portion of the adjustment block is disposed on a nut plate that is coupled with the adjustment block.

In some embodiments, the manual treadmill also includes: a second tension adjustment mechanism comprising a second knob affixed to a second threaded rod with the second threaded rod passing through a second adjustment block having a second internally threaded portion, where the second adjustment block is disposed within a front portion of the left frame; where the left frame comprises a second slot and where the second adjustment block comprises a second hole that is aligned with the second slot; the front roller having a second peg opposite the peg, and where the second peg is sized and dimensioned to pass through the second slot to couple with the second hole on the second adjustment block.

In another aspect of the inventive subject matter, a manual treadmill for animals is contemplated, the treadmill comprising: a rectangular platform frame; a rear roller coupled to the rectangular platform frame within a back portion of the rectangular platform frame; a tension adjustment mechanism comprising a knob affixed to a threaded rod with the threaded rod at least partially disposed within an adjustment block having an internally threaded portion, where the adjustment block is disposed within a front portion of the rectangular platform frame; where an interior side of the front portion of the rectangular platform frame comprises a slot and wherein the adjustment block comprises a hole that is aligned with the slot; a front roller having a peg that is sized and dimensioned to pass through the slot to couple with the hole on the adjustment block; a belt platform disposed between the front roller and the rear roller; and a belt connecting the rear roller to the front roller.

In some embodiments, the manual treadmill further includes a leash frame, where the leash frame couples with the rectangular platform frame and the leash frame comprises a connection point at a top portion. The treadmill can also include front legs coupled with the platform frame at a front portion, wherein the front legs comprise through holes to facilitate angle adjustments of the platform frame relative to horizontal. In some embodiments, the treadmill also has a horizontal cross member that couples with the front legs. It can also have a sheet of material that couples with the horizontal cross member and the front legs to improve sheer strength of the structure. In some embodiments, the internally threaded portion is disposed on a nut plate that is coupled with the adjustment block.

The treadmill can also include: a second tension adjustment mechanism comprising a second knob affixed to a second threaded rod with the second threaded rod at least partially disposed within a second adjustment block having a second internally threaded portion, where the second adjustment block is disposed within the front portion of the rectangular platform frame; where a second interior side of the front portion of the rectangular platform frame comprises a second slot and wherein the second adjustment block comprises a second hole that is aligned with the second slot; and the front roller having a second peg on an opposite side from the peg, where the second peg is sized and dimensioned to pass through the second slot to couple with the second hole on the second adjustment block.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWING

FIG. 1A shows a treadmill of the inventive subject matter.

FIG. 1B shows a zoomed in portion of the treadmill.

FIG. 2 shows a side cutaway view of the treadmill.

FIG. 3 shows a top portion of a leash frame coupled with the treadmill.

FIG. 4 shows a closer view of the front portion of the treadmill.

FIG. 5 is a cutaway view showing a tension adjustment mechanism of the treadmill.

FIG. 6 shows an exploded, cutaway view of the same.

FIG. 7 is a cutaway view of a back portion of the treadmill showing where a rear roller couples with the treadmill's frame.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

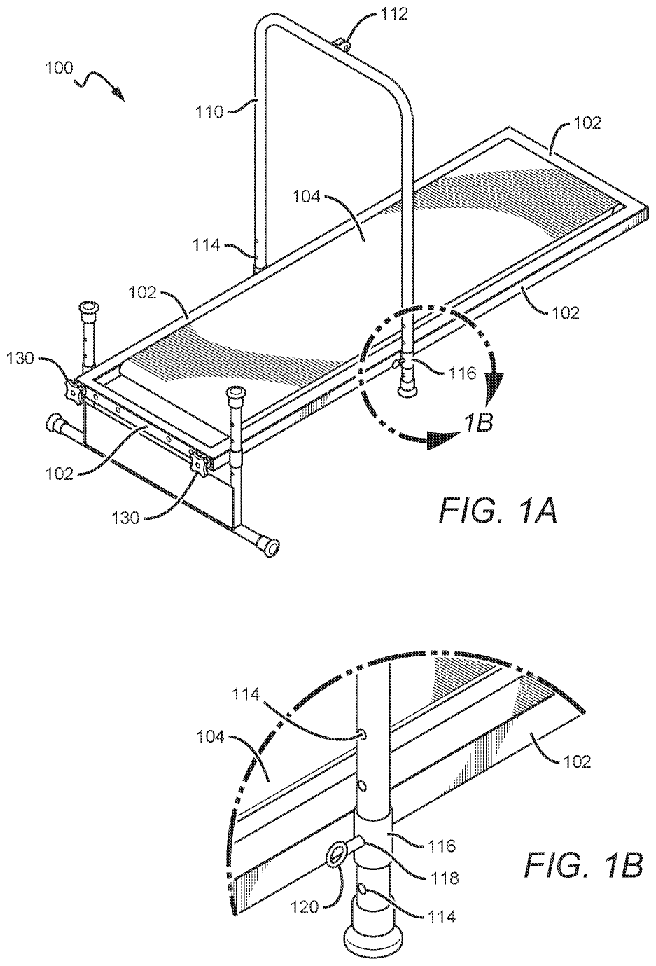

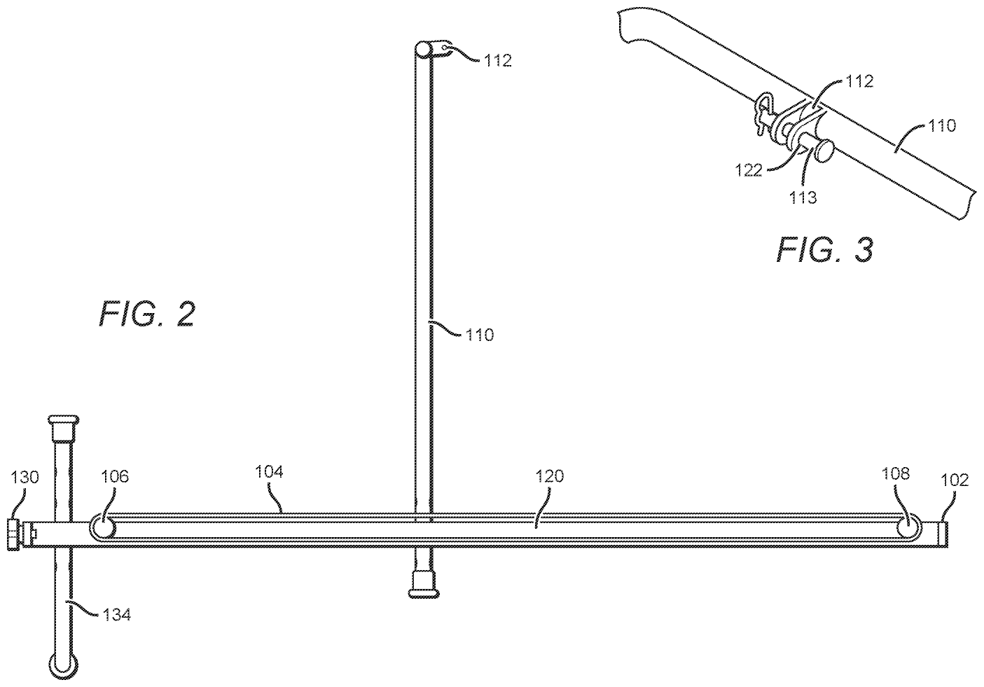

Systems of the inventive subject matter are directed to a manual treadmill for dogs. Use with other animals is also contemplated, though this application will be directed toward examples with dogs. FIG. 1A shows manual treadmill 100 from a top right perspective. As seen in at least FIGS. 1A-2, treadmill 100 includes a platform frame 102, a belt 104, a front roller 106, a back roller 108, a leash frame 110, tension adjustment mechanisms having knobs 130 that are used to adjust belt tension, along with other components described below in more detail.

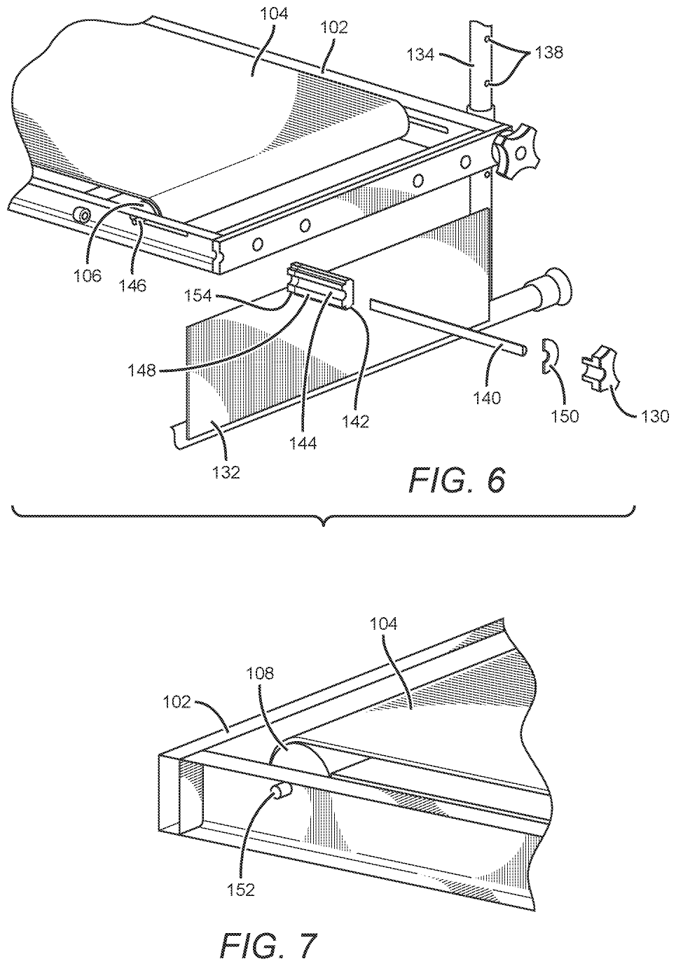

Knobs 130 that are part of the tension adjustment mechanisms are disposed on either side of the front corners of frame 102. How tension adjustment mechanisms function is described in more detail below regarding FIGS. 5 and 6. Leash frame 110 includes a connection point 112 on a top portion. Connection point 112 is designed to facilitate connecting a dog to the leash frame via, e.g., a leash or other form of lead. Leash frame 110 comprises a U-shaped frame where the ends of the U-shaped arms couple with frame 102. Holes 114 disposed along end portions of the leash frame 110 facilitate adjusting leash frame 110 height. In some embodiments, connection point 112 comprises a locking D-ring and in some embodiments, it comprises a push pin. It is contemplated that connection point 112 can receive a clevis pin 113, as shown in FIG. 3. Clevis pin 113 can facilitate quick attachment of, e.g., coupling mechanisms featured on leashes for animals, carabiners, or the like.

FIG. 1B shows a zoomed in view of a portion of FIG. 1A, showing how leash frame 110 couples with frame 102. Leash frame 110 couples with frame in collars 116 that are disposed on either side of frame 102, where collars 116 include through holes 118 (FIG. 1B shows one collar 116 with pin 120 disposed therein). Pins 116 can thus pass through holes 118 that exist on both collars 116 and also through holes 114 in leash frame 110. Because holes 114 are numerous and placed some distance apart, leash frame 110 height can be adjusted to accommodate different sized animals. E.g., positioning the top portion of leash frame 110 higher allows larger animals to use the system.

FIG. 2 shows a cutaway view of treadmill 100. In the cutaway view, front roller 106 and back roller 108 are visible, along with belt platform 120. Belt platform 120 comprises a flat sheet of material that is sized and dimensioned to support an animal's weight. When, e.g., a dog uses treadmill 100, it steps on belt 104, which presses against belt platform 120. Selecting materials for both belt 104 and belt platform 120 that results in low coefficients of both static and dynamic friction can improve embodiments. In some embodiments, belt platform 120 can be made from a hard plastic board or a metallic sheet. Belt platform 120 should be strong enough to support a dog of any size without unnecessary deformation that would impact performance or function of treadmill 100.

Back roller 108 is shown nearly adjacent to belt platform 120, as back roller 108 is held stationary relative to frame 102, there is no need for additional space to adjust its position. Front roller 106, on the other hand, can be translated left or right as shown in FIG. 2, which is why there is space shown on either side of front roller 106, including space between front roller 106 and an end of belt platform 120. As will be discussed in more detail below, knob 130 can be turned to cause front roller 106 to translate.

FIG. 3 shows a closer view of the top portion of leash frame 110. This view shows connection point 112 more clearly. Connection point 112 includes two extruded fins having holes 122 therethrough. Holes can accommodate, e.g., a pin that passes through them to facilitate coupling a leash to leash frame 110. In some embodiments, a clip such as a carabiner can be coupled with one or both holes 122.

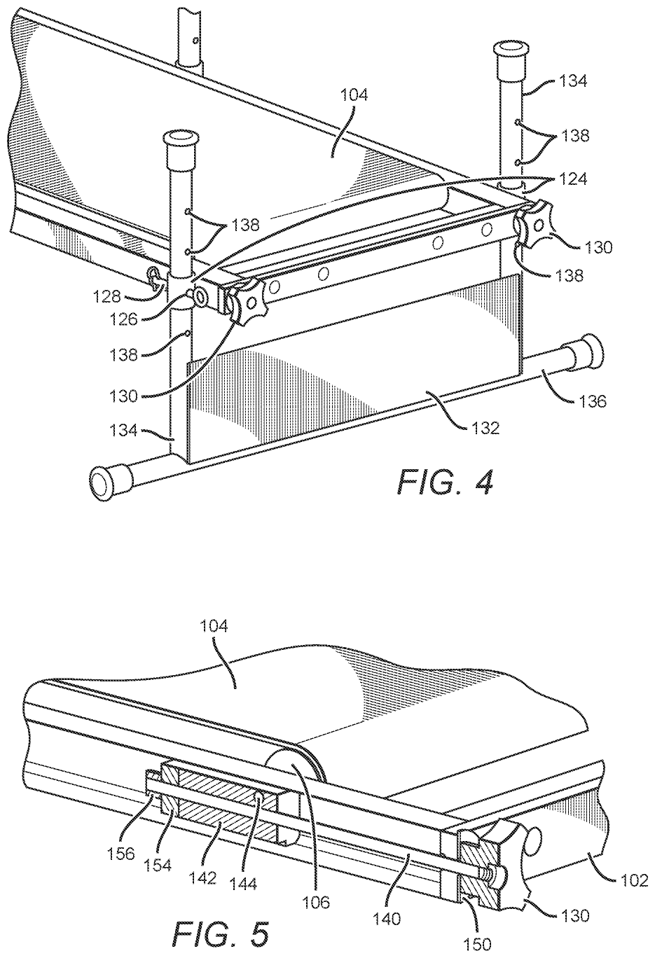

FIG. 4 shows the front portion of treadmill 100. At the front of treadmill 100, there are two front collars 124. Front collars 124, like collars 116, include through holes 126 that are sized and dimensioned to accommodate pins 128. Both front collars 124 feature through holes 126 and pins 128, though only the left-most collar shows these features in FIG. 4 because the other side is visually obscured. It should be understood that the collars and associated features can be made symmetrically.

Adjustment knobs 130 are also visible in FIG. 4, along with a front stability sheet 132. Front stability sheet 132 couples with both front legs 134 as well as with cross member 136, thereby providing sheer strength to the structure. As shown in FIG. 4, stability sheet 132 is coupled with front legs 134 and cross member 136 such that it covers front portions of those components. In some embodiments, stability sheet 132 can be coupled with front legs 134 and cross member 136 such that stability sheet 132 fits within space formed between those components. Stability sheet 132 can be coupled to front legs 134 and cross member 136 by weld, fastener, adhesive, or the like. Front legs 134 feature through holes 138 that are spaced apart along the length of front legs 134. These holes work in coordination with through holes 126 on front collars 124 to facilitate changing elevation of the front end of treadmill 100 by pins 128 through both a collar and a front leg to hold that front leg in place relative to that collar. Changing relative position of front legs to collars can result in the top surface of belt 104 taking on different angles relative to horizontal.

FIG. 5 shows a cutaway view of frame 102 along a side of frame 102. This view shows internal components associated with knob 130 on the left side of treadmill 100. Knob 130 is fixedly coupled with threaded rod 140 (e.g., such that rotating knob 130 also rotates threaded rod 140). Threaded rod 140 then couples with adjustment block 142 via an internally threaded hole in adjustment block 142. In some embodiments, the internally threaded hole comprises internal threads (e.g., internal threads 148) cut into adjustment block 142, and in other embodiments, the internally threaded hole is part of a nut or nut plate that is coupled with adjustment block 142 via weld, adhesive, fastener, pressure fit, or the like. As seen in FIGS. 5 and 6, adjustment block 142 has a nut plate 154 coupled thereto. Finally, threaded rod 140 includes a locking end cap 156 that is fixedly coupled with threaded rod 140 (e.g., by weld, adhesive, pressure fit, etc.) to prevent adjustment block 142 from decoupling from threaded rod 140 if threaded rod is turned too far.

Thus, turning knob 130 causes adjustment block 142 to translate within the treadmill's hollow side frame. Block 142 additionally includes a hole 144 to receive peg 146 that is part of front roller 106. Peg 146 is visible in FIG. 6, which shows the tightening mechanism in an exploded view. When exploded, knob 130 is shown disconnected from threaded rod 140. Internal threads 148 are visible within a portion of adjustment block 142. Upon assembly, threaded rod 140 is fixedly coupled with knob 130 with washer 150 disposed between knob 130 and frame 102. Washer 150 can reduce wear on frame 102 that might otherwise be caused by rotating knob 130 while it is directly against frame 102. Thus, upon turning knob 130, threaded rod 140 rotates and its threads interact with internal threads 148 to cause block 142 to translate. When block 142 translates, it causes front roller to move, thereby tightening or loosening the belt.

FIG. 7 shows a cutaway view of a back corner of treadmill 100. This view shows back roller 108 with peg 152 disposed within a hole in frame 102. Back roller 108 is therefore held stationary by and relative to frame 102, and by remaining stationary, tension in belt 104 can be adjusted by turning knobs 130 to pull each associated block (e.g., block 142 and its symmetrically disposed counterpart on the right side)—and by extension, front roller 106—toward or away from back roller 108. Changing tension in belt 104 can also impact resistance, so if higher resistance is needed (e.g., for a heavier dog or to account for a steeper incline), belt tension can be adjusted to create more tension and thus more resistance.

In treadmill 100, knobs 130 can be turned independently from one another. Thus, to evenly increase tension across belt 104, both knobs 130 should be turned such that approximately even tension is applied to belt 104.

Thus, specific systems directed to manual treadmills for dogs have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A manual treadmill for animals, comprising:
a platform frame comprising a rear frame, a left frame, a right frame, and a front frame, wherein the rear frame, the left frame, the right frame, and the front frame create the platform frame as a rectangle;
a rear roller coupled between the left frame and the right frame at a back portion of the platform frame;
a tension adjustment mechanism comprising a knob affixed to a threaded rod with the threaded rod passing through an adjustment block having an internally threaded portion, wherein the adjustment block is disposed within a front portion of the right frame;
wherein the right frame comprises a slot and wherein the adjustment block comprises a hole that is aligned with the slot;
a front roller having a peg that is sized and dimensioned to pass through the slot to couple with the hole on the adjustment block;
a belt platform disposed between the rear frame, the front frame, the left frame, and the right frame; and
a belt connecting the rear roller to the front roller such that the belt platform is disposed within the belt.

2. The manual treadmill of claim 1, further comprising a leash frame, wherein the leash frame couples with both the right frame and the left frame, and the leash frame comprises a connection point.

3. The manual treadmill of claim 1, further comprising front legs coupled with the platform frame at a front portion, wherein the front legs comprise through holes to facilitate angle adjustments of the platform frame relative to horizontal.

4. The manual treadmill of claim 3, further comprising a horizontal cross member that couples with the front legs.

5. The manual treadmill of claim 4, further comprising a sheet of material that couples with the horizontal cross member and the front legs.

6. The manual treadmill of claim 1, wherein the internally threaded portion is disposed on a nut plate that is coupled with the adjustment block.

7. The manual treadmill of claim 1, further comprising:
a second tension adjustment mechanism comprising a second knob affixed to a second threaded rod with the second threaded rod passing through a second adjustment block having a second internally threaded portion, wherein the second adjustment block is disposed within a front portion of the left frame;
wherein the left frame comprises a second slot and wherein the second adjustment block comprises a second hole that is aligned with the second slot;
the front roller having a second peg opposite the peg, and wherein the second peg is sized and dimensioned to pass through the second slot to couple with the second hole on the second adjustment block.

8. A manual treadmill for animals, comprising:
a rectangular platform frame;
a rear roller coupled to the rectangular platform frame within a back portion of the rectangular platform frame;
a tension adjustment mechanism comprising a knob affixed to a threaded rod with the threaded rod at least partially disposed within an adjustment block having an internally threaded portion, wherein the adjustment block is disposed within a front portion of the rectangular platform frame;
wherein an interior side of the front portion of the rectangular platform frame comprises a slot and wherein the adjustment block comprises a hole that is aligned with the slot;
a front roller having a peg that is sized and dimensioned to pass through the slot to couple with the hole on the adjustment block;
a belt platform disposed between the front roller and the rear roller; and
a belt connecting the rear roller to the front roller.

9. The manual treadmill of claim 8, further comprising a leash frame, wherein the leash frame couples with the rectangular platform frame and the leash frame comprises a connection point at a top portion.

10. The manual treadmill of claim 8, further comprising front legs coupled with the platform frame at a front portion, wherein the front legs comprise through holes to facilitate angle adjustments of the platform frame relative to horizontal.

11. The manual treadmill of claim 10, further comprising a horizontal cross member that couples with the front legs.

12. The manual treadmill of claim 11, further comprising a sheet of material that couples with the horizontal cross member and the front legs.

13. The manual treadmill of claim 8, wherein the internally threaded portion is disposed on a nut plate that is coupled with the adjustment block.

14. The manual treadmill of claim 8, further comprising:
a second tension adjustment mechanism comprising a second knob affixed to a second threaded rod with the second threaded rod at least partially disposed within a second adjustment block having a second internally threaded portion, wherein the second adjustment block is disposed within the front portion of the rectangular platform frame;
wherein a second interior side of the front portion of the rectangular platform frame comprises a second slot and wherein the second adjustment block comprises a second hole that is aligned with the second slot; and
the front roller having a second peg on an opposite side from the peg, wherein the second peg is sized and dimensioned to pass through the second slot to couple with the second hole on the second adjustment block.
